(19) United States
(12) Patent Application Publication
(10) Pub. No.: US 2015/0289481 A1
(43) Pub. Date: Oct. 15, 2015

(54) DOG SHOE

(71) Applicant: ECRIN CO., LTD, Tochigi-shi, Tochigi (JP)

(72) Inventor: Yuko Kuzuu, Kawachi-gun (JP)

(73) Assignee: ECRIN CO,. LTD, Tochigi-shi, Tochigi (JP)

(21) Appl. No.: 14/439,838

(22) PCT Filed: Oct. 30, 2013
(86) PCT No.: PCT/JP2013/080360

§ 371 Date: Apr. 30, 2015

(30) Foreign Application Priority Data
Oct. 30, 2012 (JP) 2012-251637

(51) Int. Cl. A01K 13/00

(52) U.S. Cl. CPC A01K 13/007

(57) ABSTRACT

It has been difficult to produce shoes for large dogs or rescue dogs, as dog shoes produced using only conventional sewing techniques are prone to rips and holes. The use of a synthetic resin can make dog shoes durable and make possible to produce shoes that large dogs or rescue dogs can use.

### TECHNICAL FIELD

The present invention relates to a technique of making dog shoes.

### BACKGROUND ART

Conventional dog shoes are made by using only sewing techniques.

### PRIOR ART DOCUMENTS

### Patent Documents

Japanese Patent Application Publication No. 2004-254606 (JP 2004-254606 A)

### SUMMARY OF THE INVENTION

### Problem to be Solved by the Invention

In conventional dog shoes made by using only the sewing techniques, dog's feet are sometimes rubbed by sewn parts of the shoes. Moreover, when pulled hard, the dog shoes are ripped or torn and can no longer be used.

The technique of the present invention was developed to solve such problems of the conventional dog shoes made by using only the sewing techniques, and it is an object of the technique of the present invention to make dog shoes durable.

### Means for Solving the Problem

A dog shoe, wherein a sole of the dog shoe which is formed by introducing a synthetic resin into a mold covers a region from toes to a carpus or hock (tarsus), a bag which is made of cloth and in which a dog's foot is to be placed is attached to the sole of the dog shoe, one or more belts are attached to the bag in which the dog's foot is to be placed, and a joining member such as a hook and loop fastener is attached to the belt(s).

A dog shoe, wherein a bag in which a dog's foot is to be placed and one or more belts that are attached to the bag are formed as a single-piece molded article by introducing a synthetic resin into a mold, one of the belts is attached at such a position that the belt fastens a part between a carpal pad and a metacarpal pad or between a tarsal pad and a metatarsal pad, and a joining member such as a hook and loop fastener is attached to the belt(s).

A dog shoe, wherein a bag in which a dog's foot is to be placed and one or more belts that are attached to the bag are formed as a single-piece molded article by introducing a synthetic resin into a mold, a shaft made of cloth is attached to the bag of the synthetic resin in which the dog's foot is to be placed, one or more belts are attached to the cloth shaft in which the dog's foot is to be placed, one of the belts is attached at such a position that the belt fastens a part between a carpal pad and a metacarpal pad or between a tarsal pad and a metatarsal pad, and a joining member such as a hook and loop fastener is attached to the belt(s).

A dog shoe, wherein a sole of the dog shoe is formed as a single-piece molded article by introducing a synthetic resin into a mold, a bag which is made of cloth and in which a dog's foot is to be placed is attached to the sole of the dog shoe, one or more belts are attached to the bag in which the dog's foot is to be placed, one of the belts is attached at such a position that the belt fastens a part between a carpal pad and a metacarpal pad or between a tarsal pad and a metatarsal pad, and a joining member such as a hook and loop fastener is attached to the belt(s).

A dog shoe, wherein a sole of the dog shoe which is formed by introducing a synthetic resin into a mold covers a region from toes to a carpus or hock (tarsus), a bag which is made of cloth and in which a dog's foot is to be placed is attached to the sole of the dog shoe, one or more belts are attached to the bag in which the dog's foot is to be placed, one of the belts is attached at such a position that the belt fastens a part between a carpal pad and a metacarpal pad or between a tarsal pad and a metatarsal pad, and a joining member such as a hook and loop fastener is attached to the belt(s).

A dog shoe, wherein a sole of the dog shoe and one or more belts are formed as a single-piece molded article by introducing a synthetic resin into a mold, a bag in which a dog's foot is to be placed is attached to the sole of the dog shoe, one of the belts is attached at such a position that the belt fastens a part between a carpal pad and a metacarpal pad or between a tarsal pad and a metatarsal pad, and a joining member such as a hook and loop fastener is attached to the belt(s).

In the dog shoes of [0006] to [0011], the dog shoe has a tool that narrows an opening of the bag in which the dog's foot is to be placed.

In the dog shoes of [0006] to [0012], a surface of a sewn cloth is coated with a synthetic resin for reinforcement.

In the dog shoes of [0006] to [0017], the dog shoe is formed as a single-piece mold article by introducing a synthetic resin comprised of one or more selected from a mineral, a plant, a fiber, a gas, and a resin into a mold.

In the dog shoes of [0006] to [0018], a cloth is bonded to inside of the dog shoe.

In the dog shoes of [0006] to [0018], a synthetic resin is bonded or applied to inside of the dog shoe.

Resins are divided into natural resins and synthetic resins.

The natural resins include natural rubbers.

Silicone rubbers and silicone resins are included in the resins.

The synthetic resins include phenolic resins, epoxy resins, melamine resins, urea resins, unsaturated polyester resins, alkyd resins, polyurethanes, polyimides, ABS resins, AS resins, acrylic resins, silicone resins, synthetic rubbers, etc.

### Effects of the Invention

If durable dog shoes can be made, such dog shoes can be made that can be used for search and rescue dogs that work in the event of disaster. This is helpful in saving human lives etc.

If dog shoes that can be worn by large dogs for a long period of time can be made at low cost, the dog shoes can be supplied to more assistance dog users, which allows the assistance dog users to live more independently than they do now.

If small dog shoes that cannot be made by using only the conventional sewing techniques can be made with a material that is kind to dogs' feet such as a silicone resin, the shoes can be supplied to very small dogs with allergies such as a grass allergy. This helps relieve dogs' built-up stress that is caused by not being able to go for a walk, and also helps relieve symptoms other than allergic symptoms which are caused by stress, such as poor appetite.

With aging in pet dogs, there are an increasing number of dogs that have a limp. If heavy-duty shoes can be supplied to such dogs, the dogs will need to take less medication etc. for leg or foot injuries and will maintain their health, which relieves dogs' and dog owners' stress.

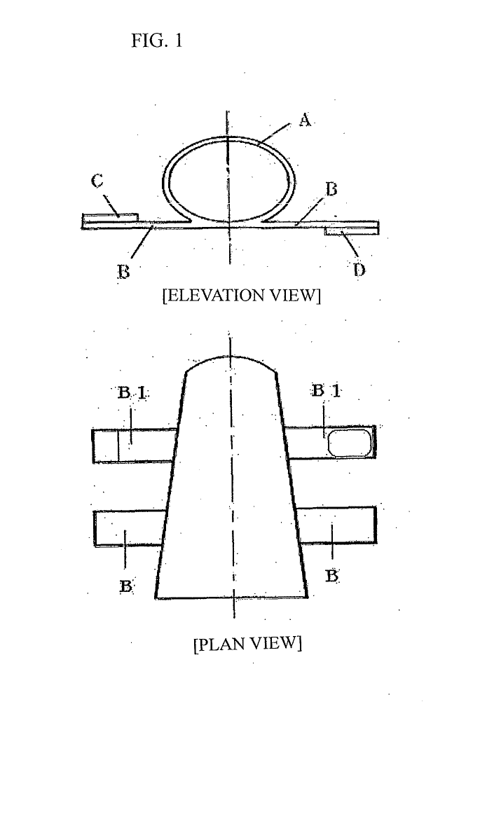

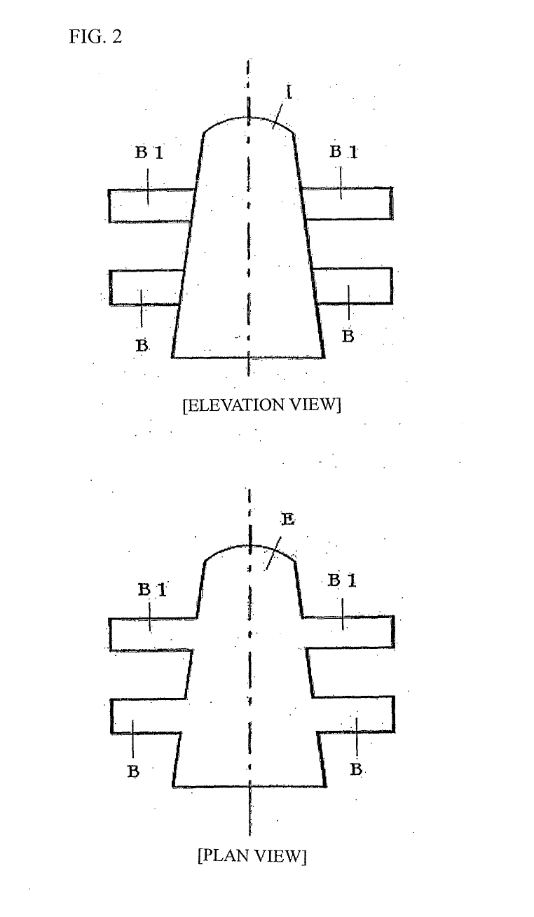

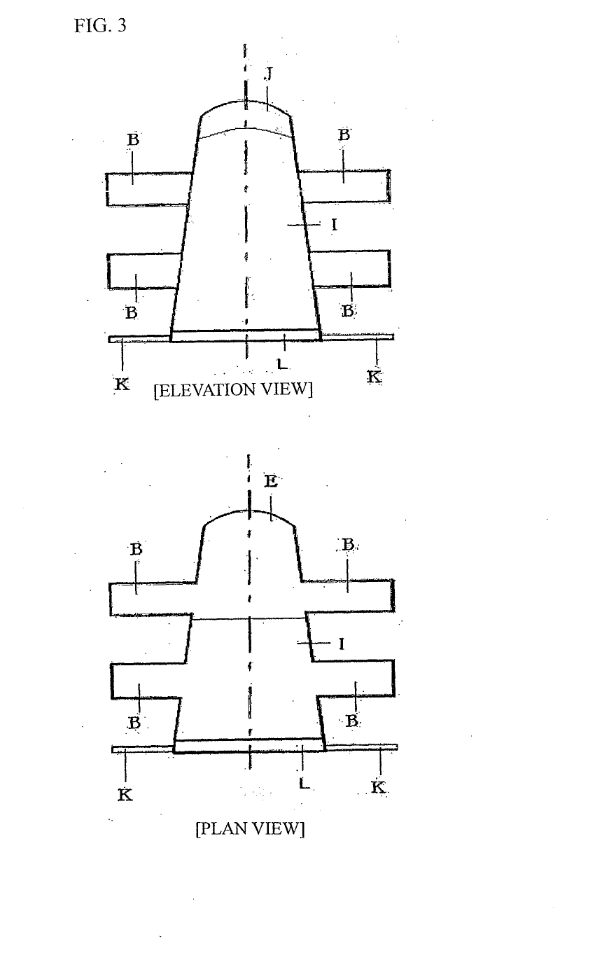

### BRIEF DESCRIPTION OF THE DRAWINGS

[FIG. 1] FIG. 1 shows a dog shoe having belts that are tightened between a carpal pad and a metacarpal pad or between a tarsal pad and a metatarsal pad.

[FIG. 2] FIG. 2 shows a dog shoe in which a bag in which a dog's foot is to be placed is attached to a single-piece molded article produced by integrally molding a portion from a shoe sole (reference character E) to toes and belts, and the dog shoe has a lace for narrowing an opening.

[FIG 3] FIG. 3 shows a dog shoe that has a lace for narrowing an opening and that has no belt.

### MODES FOR CARRYING OUT THE INVENTION

### First Embodiment

A dog shoe, wherein a sole of the dog shoe which is formed by introducing a melamine resin into a mold covers a region from toes to a carpus or hock (tarsus), a shaft which is made of artificial leather and in which a dog's foot is to be placed is attached to the sole of the dog shoe, three pairs of belts are attached to the shaft in which the dog's foot is to be placed, and the belts have a button and a buttonhole.

### Second Embodiment

A dog shoe, wherein a bag in which a dog's foot is to be placed and three pairs of belts attached to the bag are formed as a single-piece molded article by introducing an unsaturated polyester resin into a mold, one of the three pairs of belts are attached at such positions that the pair of belts fasten a part between a carpal pad and a metacarpal pad or between a tarsal pad and a metatarsal pad, and a hook and loop fastener is attached to the belts.

### Third Embodiment

A dog shoe, wherein a bag in which a dog's foot is to be placed and seven pairs of belts attached to the bag are formed as a single-piece molded article by introducing a silicone resin into a mold, a shaft made of cotton canvas fabric is attached to the bag of the silicone resin in which the dog's foot is to be placed, three pairs of belts are attached to the shaft of the cotton canvas fabric in which the dog's foot is to be placed, two of the three pairs of belts are attached at such positions that the two pairs of belts fasten a part between a carpal pad and a metacarpal pad or between a tarsal pad and a metatarsal pad, and a hook and loop fastener is attached to the belts.

### Fourth Embodiment

A dog shoe, wherein a sole of the dog shoe is formed as a single-piece molded article by introducing an ABS resin into a mold, a shaft which is made of ester canvas and in which a dog's foot is to be placed is attached to the sole of the dog shoe, two pairs of belts are attached to the shaft in which the dog's foot is to be placed, one of the two pairs of belts are attached at such positions that the pair of belts fasten a part between a carpal pad and a metacarpal pad or between a tarsal pad and a metatarsal pad, and a hook is attached to the belts.

### Fifth Embodiment

A dog shoe, wherein a sole of the dog shoe which is formed by introducing an alkyd resin into a mold covers a region from toes to a carpus or hock (tarsus), a shaft which is made of Katsuragi fabric and in which a dog's foot is to be placed is attached to the sole of the dog shoe, five sets of belts are attached to the shaft in which the dog's foot is to be placed, two of the five sets of belts are attached at such positions that the two sets of belts fasten a part between a carpal pad and a metacarpal pad or between a tarsal pad and a metatarsal pad, and the belts has a button and a buttonhole.

### Sixth Embodiment

A dog shoe, wherein a sole of the dog shoe and three pairs of belts are formed as a single-piece molded article by introducing polyurethane into a mold, a shaft that is made of leather and in which a dog's foot is to be placed is attached to the sole of the dog shoe, one of the three pairs of belts are attached at such positions that the pair of belts fasten a part between a carpal pad and a metacarpal pad or between a tarsal pad and a metatarsal pad, and a buckle is attached to the belts.

### Seventh Embodiment

A dog shoe, wherein a sole of the dog shoe which is formed by introducing an AS resin into a mold covers a region from toes to a carpus or hock (tarsus), a bag which is made of nylon fabric and in which a dog's foot is to be placed is attached to the sole of the dog shoe, four pairs of belts are attached to the bag in which the dog's foot is to be placed, the belts have a lace and a lace hole through which the lace is inserted, the dog shoe has a lace for narrowing an opening of the bag in which the dog's foot is to be placed and a lace hole through which the lace is inserted, and a surface of a sewn cloth is coated with a synthetic resin for reinforcement.

### Eighth Embodiment

A dog shoe, wherein a bag in which a dog's foot is to be placed and three pairs of belts attached to the bag are formed as a single-piece molded article by introducing an acrylic resin into a mold, two of the three pairs of belts are attached at such positions that the two pairs of belts fasten a part between a carpal pad and a metacarpal pad or between a tarsal pad and a metatarsal pad, a hook and loop fastener is attached to the belts, and the dog shoe has a lace for narrowing an opening of the bag in which the dog's foot is to be placed and a lace hole through which the lace is inserted.

### Ninth Embodiment

A dog shoe, wherein a sole of the dog shoe which is formed by introducing ilmenite and a phenolic resin into a mold covers a region from toes to a carpus or hock (tarsus), a shaft which is made of synthetic leather fabric and in which a dog's foot is to be placed is attached to the sole of the dog shoe, three sets of belts are attached to the shaft in which the dog's foot is to be placed, the belts have a button and a buttonhole, and a surface of a sewn cloth is coated with a synthetic resin for reinforcement.

### Tenth Embodiment

A dog shoe, wherein a bag in which a dog's foot is to be placed and four pairs of belts attached to the bag are formed as a single-piece molded article by introducing native iron and a urea resin into a mold, one of the four pairs of belts are attached at such positions that the pair of belts fasten a part between a carpal pad and a metacarpal pad or between a tarsal pad and a metatarsal pad, and a hook is attached to the belts.

### Eleventh Embodiment

A dog shoe, wherein a bag in which a dog's foot is to be placed and three sets of belts attached to the bag are formed as a single-piece molded article by introducing ground walnut shells and an ABS resin into a mold, a shaft made of nylon fabric is attached to the bag in which the dog's foot is to be placed, two sets of belts are attached to the shaft of the nylon fabric in which the dog's foot is to be placed, one of the two sets of belts are attached at such positions that the set of belts fasten a part between a carpal pad and a metacarpal pad or between a tarsal pad and a metatarsal pad, a buckle is attached to all the belts, and a surface of a sewn cloth is coated with a synthetic resin for reinforcement.

### Twelfth Embodiment

A dog shoe, wherein a sole of the dog shoe is formed as a single-piece molded article by introducing powdered coconut shells and polyurethane into a mold, a shaft which is made of Katsuragi fabric and in which a dog's foot is to be placed is attached to the sole of the dog shoe, six pairs of belts are attached to the shaft in which the dog's foot is to be placed, two of the six pairs of belts are attached at such positions that the two pairs of belts fasten a part between a carpal pad and a metacarpal pad or between a tarsal pad and a metatarsal pad, a hook and loop fastener is attached to the belts, and a surface of a sewn cloth is coated with a synthetic resin for reinforcement.

### Thirteenth Embodiment

A dog shoe, wherein a sole of the dog shoe which is formed by introducing ground barley and polyimide into a mold covers a region from toes to a carpus or hock (tarsus), a bag which is made of ester canvas and in which a dog's foot is to be placed is attached to the sole of the dog shoe, five pairs of belts are attached to the bag in which the dog's foot is to be placed, two of the five pairs of belts are attached at such positions that the two pairs of belts fasten a part between a carpal pad and a metacarpal pad or between a tarsal pad and a metatarsal pad, a zipper is attached to the belts, and a surface of a sewn cloth is coated with a synthetic resin for reinforcement.

### Fourteenth Embodiment

A dog shoe, wherein a sole of the dog shoe and four pairs of belts are formed as a single-piece molded article by introducing cotton and an alkyd resin into a mold, a shaft which is made of nylon fabric and in which a dog's foot is to be placed is attached to the sole of the dog shoe, one of the four pairs of belts are attached at such positions that the pair of belts fasten a part between a carpal pad and a metacarpal pad or between a tarsal pad and a metatarsal pad, a hook and loop fastener is attached to the belts, and a surface of a sewn cloth is coated with a synthetic resin for reinforcement.

### Fifteenth Embodiment

A dog shoe, wherein a bag in which a dog's foot is to be placed and six pairs of belts attached to the bag are formed as a single-piece molded article by introducing nitrogen and polyurethane into a mold, a shaft made of Katsuragi fabric is attached to the bag in which the dog's foot is to be placed, four pairs of belts are attached to a cloth bag in which the dog's foot is to be placed, two of the four pairs of belts are attached at such positions that the two pairs of belts fasten a part between a carpal pad and a metacarpal pad or between a tarsal pad and a metatarsal pad, a hook and loop fastener is attached to all of the joining portions, cotton fabric is bonded to the inside of the bag in which the dog's foot is to be placed, and a surface of a sewn cloth is coated with a synthetic resin for reinforcement.

### Sixteenth Embodiment

A dog shoe, wherein a sole of the dog shoe is formed as a single-piece molded article by introducing hydrogen and a phenolic resin into a mold, a bag which is made of nylon fabric and in which a dog's foot is to be placed is attached to the sole of the dog shoe, five pairs of belts are attached to the bag in which the dog's foot is to be placed, one of the five pairs of belts are attached at such positions that the pair of belts fasten a part between a carpal pad and a metacarpal pad or between a tarsal pad and a metatarsal pad, a hook is attached to the belts, the inside of the bag in which the dog's foot is to be placed is coated with a silicone resin, and a surface of a sewn cloth is coated with a synthetic resin for reinforcement.

### Seventeenth Embodiment

A dog shoe, wherein a sole of the dog shoe is formed as a single-piece molded article by introducing a melamine resin and an epoxy resin into a mold, a bag which is made of ester canvas and in which a dog's foot is to be placed is attached to the sole of the dog shoe, three pairs of belts are attached to the bag in which the dog's foot is to be placed, one of the three pairs of belts are attached at such positions that the pair of belts fasten a part between a carpal pad and a metacarpal pad or between a tarsal pad and a metatarsal pad, a buckle is attached to the belts, Katsuragi fabric is bonded to the inside of the bag in which the dog's foot is to be placed, the dog shoe has a lace for narrowing an opening of the bag in which the dog's foot is to be placed and a lace hole through which the lace is inserted, and a surface of a sewn cloth is coated with a synthetic resin for reinforcement.

### Description of the Reference Numerals

A: bag in which a dog's foot is to be placed
B: belt
B1: belt for fastening a part between a carpal pad and a metacarpal pad or between a tarsal pad and a metatarsal pad
C: hook and loop fastener
D: hook and loop fastener
E: shoe sole
I: cloth bag
J: toe portion standing from the shoe sole (reference character E)
K: lace for narrowing the opening of the bag in which the dog's foot is to be placed
L: lace hole

1. A dog shoe, comprising:
a sole of the dog shoe which is formed by introducing a synthetic resin into a mold covers a region from toes to a carpus or hock, a bag which is made of cloth and in which a dog's foot is to be placed is attached to the sole of the dog shoe, one or more belts are attached to the bag in which the dog's foot is to be placed, and a joining member such as a hook and loop fastener is attached to the belt(s).

2. The dog shoe according to claim 1, wherein
one or more of the belts are attached at such a position that the one or more of the belts fasten a part between a carpal pad and a metacarpal pad or between a tarsal pad and a metatarsal pad.

3. The dog shoe according to claim 1, wherein
the dog shoe has a tool that narrows an opening of the bag in which the dog's foot is to be placed.

4. The dog shoe according to claim 1, wherein
a surface of a sewn cloth of the dog shoe is coated with a synthetic resin for reinforcement.

5. The dog shoe according to claim 2, wherein
the dog shoe has a tool that narrows an opening of the bag in which the dog's foot is to be placed.

6. The dog shoe according to claim 2, wherein
a surface of a sewn cloth of the dog shoe is coated with a synthetic resin for reinforcement.

7. The dog shoe according to claim 3, wherein
a surface of a sewn cloth of the dog shoe is coated with a synthetic resin for reinforcement.

8. The dog shoe according to claim 5, wherein
a surface of a sewn cloth of the dog shoe is coated with a synthetic resin for reinforcement.
